(19) United States
(12) Patent Application Publication
(10) Pub. No.: US 2019/0377941 A1
(43) Pub. Date: Dec. 12, 2019

(54) CHARACTER RECOGNITION APPARATUS AND CHARACTER RECOGNITION METHOD

(71) Applicant: SHARP KABUSHIKI KAISHA, Sakai City (JP)

(72) Inventors: TOHRU NAKANISHI, Sakai City (JP); ZENKEN KIN, Osaka (JP)

(21) Appl. No.: 16/432,252

(22) Filed: Jun. 5, 2019

(30) Foreign Application Priority Data
Jun. 11, 2018 (JP) 2018-111354

(51) Int. Cl. G06K 9/00; G06K 9/34

(52) U.S. Cl. CPC G06K 9/00409; G06K 2209/01; G06K 9/00429; G06K 9/344

(57) ABSTRACT

A book digitization apparatus includes: a three-dimensional data generation unit that generates three-dimensional data of a book; a two-dimensional page data generation unit that generates two-dimensional page data from the three-dimensional data; and a character recognition unit that extracts a plurality of unique points of a character from a plurality of points which are included in the two-dimensional page data and each of which has a value corresponding to ink, thereby recognizing the character.

### BACKGROUND

### 1. Field

The present disclosure relates to a character recognition apparatus and a character recognition method that recognize characters displayed in a book.

### 2. Description of the Related Art

When a book is opened for reading, the book is damaged in some cases. In particular, an old book may be damaged or destroyed when being opened. For example, an ancient scroll burnt by a volcanic eruption in ancient Roman times was discovered in Italy. It is difficult to read such an ancient document with unaided eyes because it is severely blackened, and it is difficult to unroll because it is fragile. Thus, by performing X-ray phase-contrast tomography on such a book, three-dimensional data of the book may be acquired without damaging the book.

A book digitization apparatus that generates two-dimensional data corresponding to each page of a book from three-dimensional data as described above is known. A book digitization apparatus described in International Publication No. WO2017/131184 specifies a page region corresponding to a page of a book by using three-dimensional data of the book and maps a character string or a graphic (before recognition) in the page region to a two-dimensional plane, thereby generating two-dimensional page data including the character string or the graphic (before recognition) displayed in the book. Note that, the character string or the graphic here means a plurality of points before recognition, and the character string or the graphic is recognized from the plurality of points.

Following the generation of the two-dimensional page data by the book digitization apparatus described above is a step of recognizing the character string or the graphic displayed in the book. In this step, the character or the graphic is recognized by scanning a plurality of points (nodes) which are included in the two-dimensional page data and each of which has a value (for example, intensity of reflected light of an X-ray) corresponding to ink.

In the recognition step described above, the two-dimensional page data also includes points each having a value corresponding to a background instead of ink, and as a result a plurality of points including the points corresponding to the background are to be scanned, thus posing a problem of increased time to recognize the character.

It is desirable to provide a character recognition apparatus and a character recognition method that are able to efficiently recognize a character from two-dimensional page data.

### SUMMARY

To cope with the aforementioned problem, a character recognition apparatus according to an aspect of the disclosure includes: a three-dimensional data generation unit that captures an image of a book and generates three-dimensional data of the book; a two-dimensional page data generation unit that generates, from the three-dimensional data, two-dimensional page data that includes information about a plurality of points each having a value corresponding to ink or a value corresponding to a background; and a recognition unit that extracts a plurality of unique points of a character from the plurality of points which are included in the two-dimensional page data and each of which has the value corresponding to the ink, thereby recognizing the character.

To cope with the aforementioned problem, a character recognition method according to an aspect of the disclosure includes: capturing an image of a book and generating three-dimensional data of the book; generating, from the three-dimensional data, two-dimensional page data that includes information about a plurality of points each having a value corresponding to ink or a value corresponding to a background; and extracting a plurality of unique points of a character from the plurality of points which are included in the two-dimensional page data and each of which has the value corresponding to the ink, thereby recognizing the character.

### BRIEF DESCRIPTION OF THE DRAWINGS

FIG. 1 is a block diagram illustrating a principal configuration of a book digitization apparatus according to Embodiment 1 of the disclosure;

FIG. 2 is a flowchart illustrating an example of a flow of processing of the book digitization apparatus;

FIG. 3 illustrates nodes in one region determined by a character region determining unit included in the book digitization apparatus;

FIG. 4 illustrates unique points of a character “hiragana character A”;

FIG. 5 illustrates a state where the unique points of the character “hiragana character A” are extracted from a certain region by a character determining unit included in the book digitization apparatus;

FIG. 6 is a block diagram illustrating a principal configuration of a book digitization apparatus according to Embodiment 2 of the disclosure;

FIGS. 7A and 7B are views for explaining an example of a method of generating unique point data by a unique point data generation unit included in the book digitization apparatus;

FIGS. 8A and 8B are views for explaining an example of a method of generating unique point data by the unique point data generation unit included in the book digitization apparatus; and

FIGS. 9A to 9C are views for explaining another example of a method of generating unique point data by the unique point data generation unit included in the book digitization apparatus.

### DESCRIPTION OF THE EMBODIMENTS

### Embodiment 1

An embodiment of the disclosure will be described in detail below.

### (Configuration of Book Digitization Apparatus 1A)

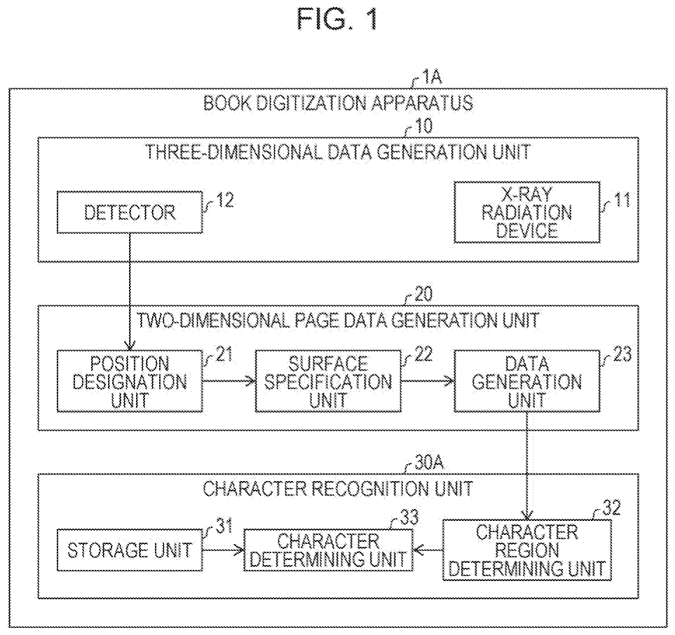

FIG. 1 is a block diagram illustrating a principal configuration of a book digitization apparatus 1A (character recognition apparatus) in the present embodiment. As illustrated in FIG. 1, the book digitization apparatus 1A includes a three-dimensional data generation unit 10, a two-dimensional page data generation unit 20, and a character recognition unit 30A (recognition unit).

The three-dimensional data generation unit 10 captures an image of a book and generates three-dimensional data of the book. The three-dimensional data generation unit 10 includes an X-ray radiation device 11 and a detector 12 as illustrated in FIG. 1.

The X-ray radiation device 11 irradiates the book with X-rays. The X-ray radiation device 11 is configured to enable the output (wavelength) of X-ray radiation to be adjusted, for example, and is able to irradiate the book with X-rays having a desired wavelength.

The detector 12 detects the X-rays radiated onto the book. The detector 12 is configured to acquire detection values which include detection positions of the X-rays and intensity of the X-rays at the positions. The detector 12 outputs the acquired detection values as three-dimensional data to the two-dimensional page data generation unit 20 (more specifically, a position designation unit 21).

The two-dimensional page data generation unit 20 generates, from the three-dimensional data generated by the three-dimensional data generation unit 10, two-dimensional page data which includes information about a plurality of points (nodes) each having a value corresponding to ink or a value corresponding to a background. The two-dimensional page data generation unit 20 includes the position designation unit 21, a surface specification unit 22, and a data generation unit 23 as illustrated in FIG. 1.

In accordance with data values of the three-dimensional data output from the detector 12, the position designation unit. 21 designates an initial point for specifying a page region. The page region is a part corresponding to each page of the book in the three-dimensional data and is a set of nodes existing on a certain surface corresponding to the page. The position designation unit 21 outputs information about the initial point to the surface specification unit 22.

The surface specification unit 22 specifies a page region connected to the initial point designated by the position designation unit 21. The surface specification unit 22 outputs a set of points corresponding to the page region and data values of the respective points to the data generation unit 23.

The data generation unit 23 converts the data of the page region specified by the surface specification unit into two-dimensional planar) page data (hereinafter, referred to as two-dimensional page data). The two-dimensional page data includes information about the plurality of points each having the value corresponding to the ink or the value corresponding to the background, and includes information about a positional relation of a plurality of characters or graphics (arrangement of the characters or the like) on a page of the book. The data generation unit 23 outputs the generated two-dimensional page data to the character recognition unit 30A (more specifically, a character region determining unit 32).

The character recognition unit 30A extracts (specifies) a plurality of unique points (indispensable character constituent points) of a character from a plurality of points which are included in the two-dimensional page data generated by the two-dimensional page data generation unit 20 and each of which has the value corresponding to the ink, thereby recognizing the character. The character recognition unit 30A includes a storage unit 31, the character region determining unit 32, and a character determining unit 33 as illustrated in FIG. 1.

The storage unit 31 stores a unique point of a character. In other words, the storage unit 31 stores a unique point of a character (for example, a hiragana character, a katakan character, a Chinese character, an alphabetical character, a numeral, or the like). The term “unique point” in the present specification denotes a point that is indispensable for constituting the character. The number of unique points of one character is not particularly limited and may differ per character. For example, the number of unique points of “hiragana character A” described below is 20.

The character region determining unit 32 determines one character region from the two-dimensional page data generated by the data generation unit 23. A known technique is able to be used as a method of determining one character region. The character region determining unit 32 determines a region for each character displayed in one piece of two-dimensional page data.

The character determining unit 33 determines a character displayed in one character region determined by the character region determining unit 32. Specifically, first, the character determining unit 33 reads information about unique points of a character, which are stored in the storage unit 31. Next, the character determining unit 33 determines whether nodes of points corresponding to the read unique points are nodes corresponding to the ink. In other words, the character determining unit 33 refers to data of the unique points stored in the storage unit 31 and extracts a plurality of unique points of the character from a plurality of nodes which are included in the two-dimensional page data and each of which has the value corresponding to the ink. Then, when all the nodes of the points corresponding to the unique points are nodes corresponding to the ink, the character determining unit 33 determines (recognizes) that the character is displayed in the region.

### (Example of Processing of Hook Digitization Apparatus 1A)

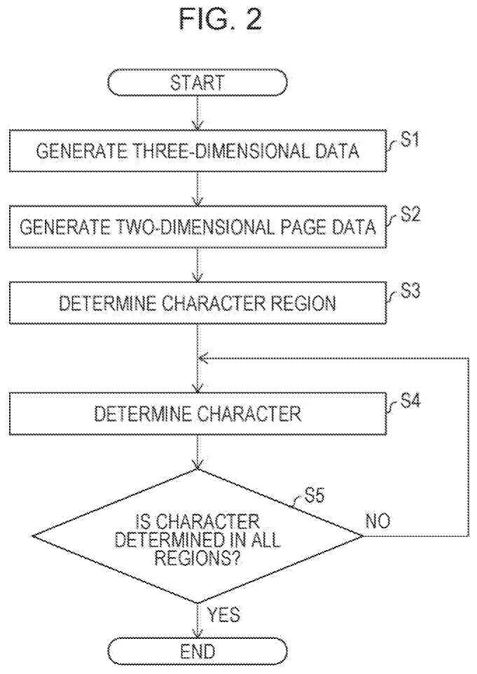

FIG. 2 is a flowchart illustrating an example of a flow of processing (character recognition method) of the book digitization apparatus 1A. As illustrated in FIG. 2, in the processing in the book digitization apparatus 1A, first, the three-dimensional data generation unit 10 captures an image of a book and generates three-dimensional data of the book (S1, three-dimensional data generation step). Specifically, the X-ray radiation device 11 irradiates the book with X-rays and the detector 12 detects the X-rays. The X-ray radiation device 11 irradiates the book with X-rays when the book is in a closed state. Some of the X-rays from the X-ray radiation device 11 are absorbed by the ink in the book.

The detector 12 detects the X-rays that have passed through the book, acquires detection values which include specific positions and intensity of the X-rays, and outputs the detected detection values as three-dimensional data to the two-dimensional page data generation unit 20 (more specifically, the position designation unit 21). The X-rays that have passed through regions where ink exists in the book are detected by the detector 12 as X-rays having intensity lower than that of X-rays that have passed through a medium (paper) of the book. A set of the detection values forms three-dimensional data which includes a point where such X-rays having low intensity are detected. The three-dimensional data is data that includes information about a position of the ink or a paper surface (background) and information about intensity of the X-rays at the position. In this manner, by capturing an image of the book by using X-rays, the three-dimensional data of the ink in the book is acquired.

Next, the two-dimensional page data generation unit 20 generates, from the three-dimensional data generated by the three-dimensional data generation unit 10, two-dimensional page data that includes information about a plurality of points (nodes) each having the value corresponding to the ink or the value corresponding to the background (S2, two-dimensional page data generation step). Specifically, first, in the three-dimensional data, the position designation unit 21 designates a linear path so that the linear path passes through at least one sheet (one page in a case where the hook has multiple pages) of overlapping media. For example, in the case where the book has multiple pages, the path is a straight line that passes through the book from a front cover to a back cover and through all pages of the book.

The position designation unit 21 designates a point, which corresponds to a threshold for distinguishing a data value of a sheet and a data value of a gap, in the path as an initial point of a page region. For example, the position designation unit 21 designates a plurality of initial points corresponding to a plurality of page regions. The position designation unit 21 outputs information about the initial point to the surface specification unit 22.

Next, the surface specification unit 22 specifies a position of: a page region determined in accordance with the in point. For example, the page region is disposed, in orthogonal coordinates of the three-dimensional data, so as to cross a unit cell constituting the orthogonal coordinates. The surface specification unit 22 specifies the page region by setting points, which have values equal to or greater than the threshold on the sides of the unit cell traversed by the page region, as points corresponding to the page region.

Next, the data generation unit 23 generates the two-dimensional page data by mapping data values of the respective points of the page region specified by the surface specification unit 22 onto a two-dimensional plane. The data values of the respective points of the two-dimensional page data substantially correspond to either the sheet (background) or the ink. A known method (for example, three-dimensional mesh deployment utilizing saddle point characteristics) is usable as a mapping method.

Next, the character recognition unit 30A recognizes characters included in the two-dimensional page data generated by the data generation unit 23 (recognition step).

Specifically, first, the character region determining unit 32 determines a region of each of the characters in the two-dimensional page data generated by the data generation unit 23 (S3).

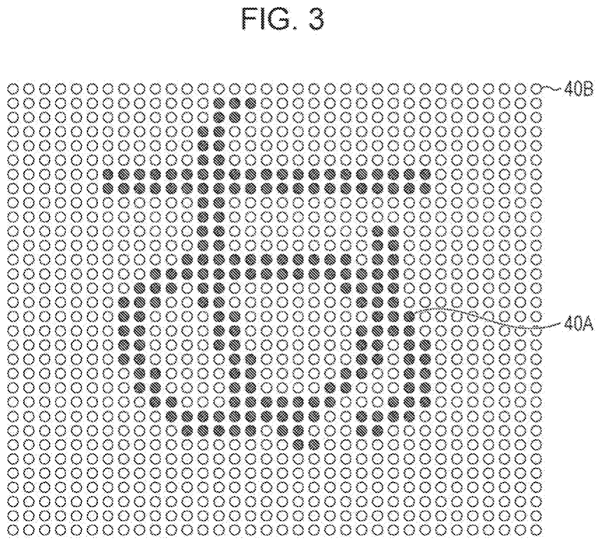

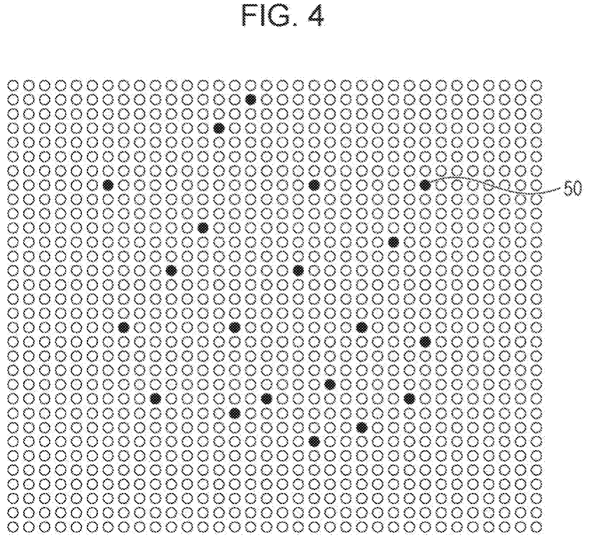

Next, the character determining unit 33 determines a character displayed in each of the regions determined by the character region determining unit 32 (S4). Here, an example in which “hiragana character A” is displayed in one region will be described. FIG. 3 illustrates nodes in one region determined by the character region determining unit 32. As illustrated in FIG. 3, the region has nodes 40A, which are nodes corresponding to the ink, and nodes 40B, which are nodes corresponding to the background, and has the character “hiragana character A” formed by the nodes 40A. Note that, for simplification, FIG. 3 illustrates the nodes in an enlarged manner so that the nodes are recognizable, but the actual interval between nodes is about several micrometers. Thus, the nodes 40A which are nodes corresponding to the ink form a node group. Such an illustration method is also applied similarly to FIGS. 4, 5 and 7A to 9C described below.

First, the character determining unit 33 reads unique points of each of the characters from the storage unit 31 and determines whether nodes of points corresponding to the read unique points are nodes corresponding to the ink.

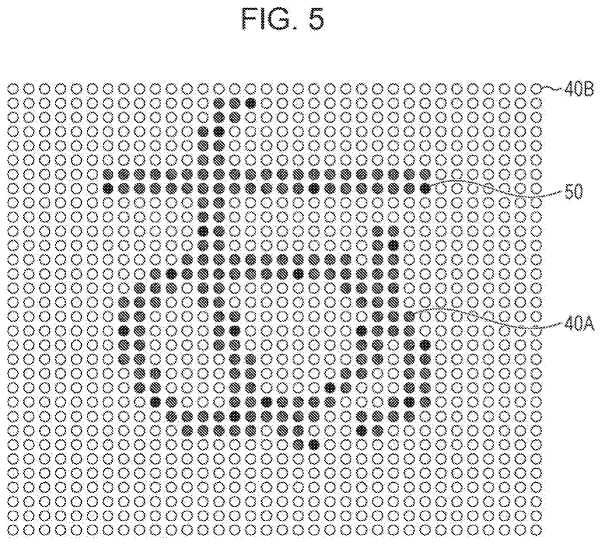

FIG. 4 illustrates unique points 50 of the character “hiragana character A”. FIG. 5 illustrates a state where the unique points of the character “hiragana character A” are extracted from the aforementioned region by the character determining unit 33. As illustrated in FIGS. 4 and 5, when the character determining unit 33 determines that all the nodes corresponding to the unique points of the character “hiragana character A” are nodes 40A, the character determining unit 33 determines that the character displayed in the region is “hiragana character A”.

Next, the character determining unit 33 determines whether the two-dimensional page data has a region in which a character is not yet determined (S5). When there is a region in which a character is not yet determined (NO in S5), the character determining unit 33 performs step 34 for the next region. On the other hand, once a character has been determined in all the regions, the book digitization apparatus 1A ends the processing.

A book digitization apparatus of the related art uses all nodes in two-dimensional page data to recognize a character. On the other hand, the book digitization apparatus 1A in the present embodiment uses only unique points of a character to recognize the character as described above. This makes it possible to reduce processing for recognizing the character. As a result, it is possible to reduce the time taken to recognize the character. In other words, the book digitization apparatus 1A is able to efficiently recognize the character from the two-dimensional page data.

Note that, the present embodiment has an aspect in which when all the nodes of the points corresponding to the unique points are nodes corresponding to the ink, it is specified that the character is displayed in the region, but there is no limitation thereto. For example, when nodes of points corresponding to a predetermined proportion (for example, 80%) or more of the plurality of unique points are nodes corresponding to the ink, it may be specified that the character is displayed in the region. This makes it possible to further reduce the processing time.

### Embodiment 2

Another embodiment of the disclosure will be described below. Note that, for convenience of description, members having the same functions as those of the members described in the aforementioned embodiment will be given the same reference signs and description thereof will not be repeated.

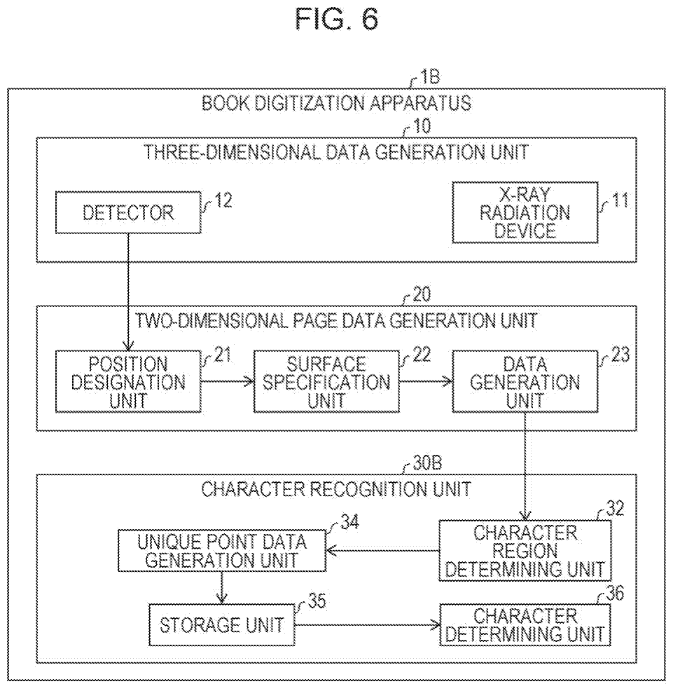

FIG. 6 is a block diagram illustrating a principal configuration of a book digitization apparatus 1B in the present embodiment. The book digitization apparatus 1B includes a character recognition unit 30B (recognition unit) instead of the character recognition unit 30A in Embodiment 1.

The character recognition unit 30B includes the character region determining unit 32, a unique point data generation unit 34, a storage unit 35, and a character determining unit 36.

The unique point data generation unit 34 generates unique point data of a character in accordance with a past character recognition result. Specifically, the unique point data generation unit 34 analyzes all nodes in one character region determined by the character region determining unit 32, and determines unique points (indispensable character constituent points) of the character. The unique point data generation unit 34 stores the generated unique point data in the storage unit 35.

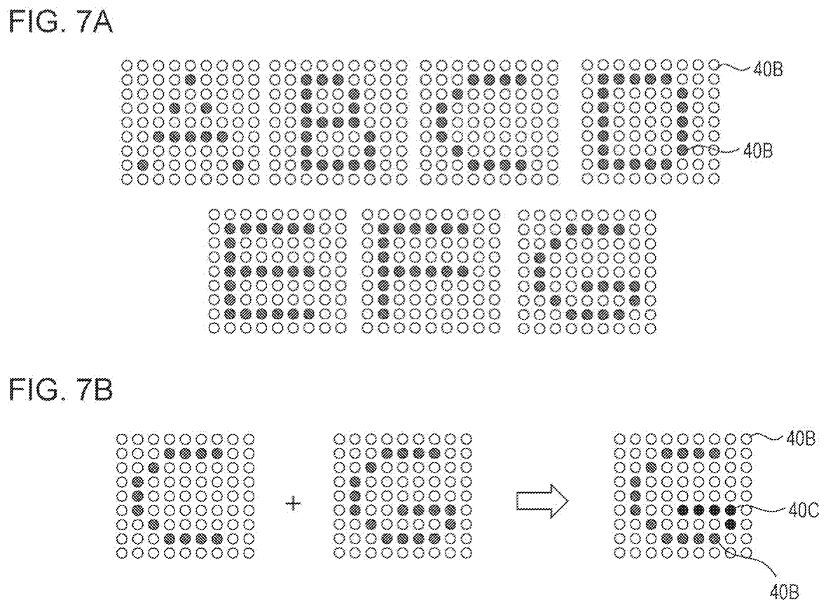

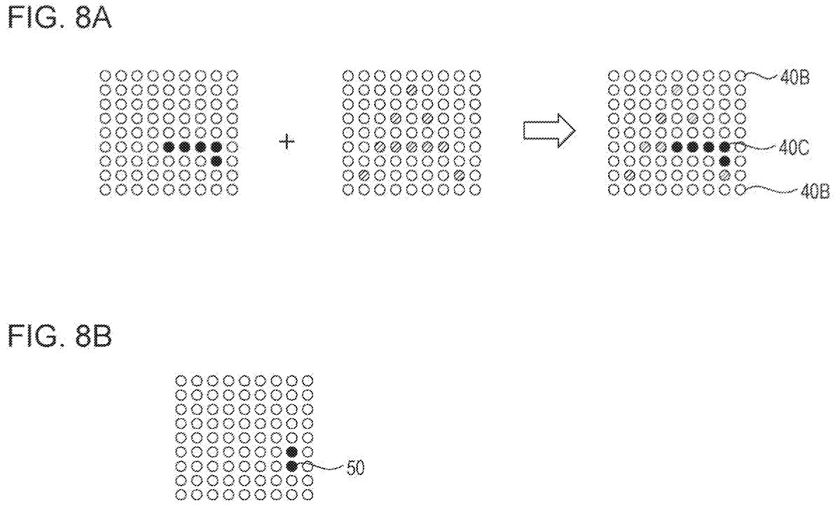

An example of a method of generating unique point data by the unique point data generation unit 34 will be described with reference to FIGS. 7A to 8B. FIGS. 7A, 7B, 8A, and 8B are views for explaining an example of a method of generating unique point data by the unique point data generation unit 34.

First, the unique point data generation unit 34 recognizes and stores characters displayed in a book. Next, the unique point data generation unit 34 determines a region (hereinafter, referred to as a single character region) in which all nodes of one character are included.

Next, as illustrated in FIG. 7A, each of the stored characters (specifically, nodes of the characters) is plotted to the single character region. A method of generating unique point data of a character “G” will be described below. As illustrated in FIG. 7B, the unique point data generation unit 34 then causes, for example, the character “G” and a character “C” to be overlapped with each other, and extracts nodes 400 which are nodes that are not overlapped with nodes of the character “C” among nodes 40A of the character “G”.

Next, the unique point data generation unit 34 causes the extracted nodes 40C to be overlapped with another character. FIG. 8A illustrates an example in which the extracted nodes 40C are overlapped with a character “A.”.

Next, as illustrated in FIG. 8B, the unique point data generation unit 34 extracts nodes 400 that are not overlapped with another character among the nodes 400 and determines the extracted nodes 40C as unique points 50 of the character “G”.

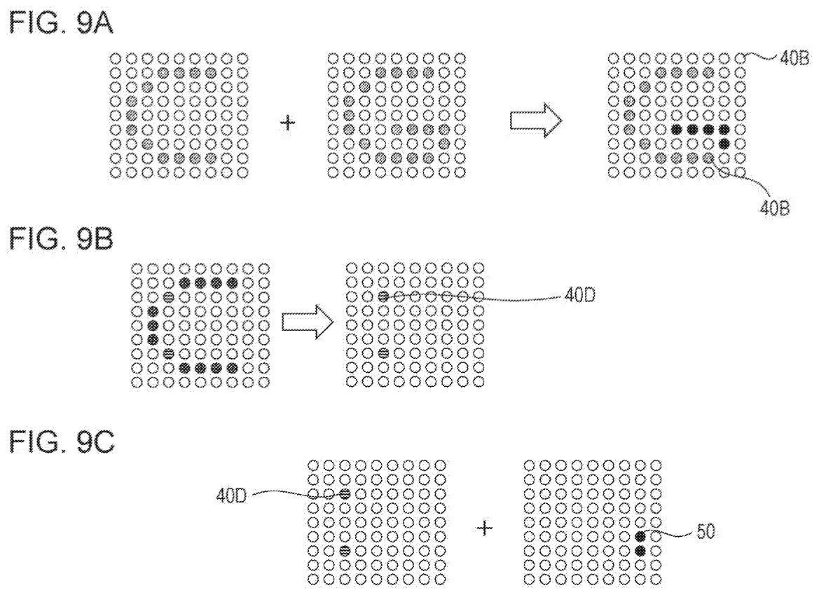

Here, another example of a method of generating unique point data by the unique point data generation unit 34 will be described with reference to FIGS. 9A to 9C. FIGS. 9A to 9C are views for explaining another example of a method of generating unique point data by the unique point data generation unit 34. Here, a method of generating unique point data of the character “C” will be described.

In a case of the character “Cu” when the character “G” and the character “C” are overlapped with each other as illustrated in FIG. 9A, all nodes 40A of the character “C” are overlapped with nodes 40A of the character “G”. In such a case, the unique point data generation unit 34 extracts nodes 40D (second unique points) that are nodes which are less likely to be overlapped with another character, as illustrated in FIG. 9B. Then, as illustrated in FIG. 9C, when (1) there are the extracted nodes 40D and (2) there is no unique point 50 of the character “G”, the unique point data generation unit 34 specifies the character as “C”. In other words, the unique point data generation unit 34 determines that the nodes 40D and the unique points 50 of the character “G” are unique points of the character “C”.

The character determining unit 36 determines a character displayed in one character region determined by the character region determining unit 32. Specifically, first, the character determining unit 36 reads information about unique points of a character stored in the storage unit 35. Next, the character determining unit 36 determines whether nodes of points corresponding to the read unique points are nodes corresponding to the ink. In other words, the character determining unit 36 refers to data of the unique points stored in the storage unit 35 and extracts a plurality of unique points of the character from a plurality of nodes which are included in two-dimensional page data and each of which has the value corresponding to the ink. Then, when all the nodes of the points corresponding to the unique points are nodes corresponding to the ink, the character determining unit 36 determines (recognizes) that the character is displayed in the region.

As described above, the book digitization apparatus TB in the present embodiment generates unique points of a character by the unique point data generation unit Thus, for example, also when unique points are specific to a character such as a handwritten character, it is possible to efficiently recognize the character.

### [Implementation Example by Software]

A control block (particularly, the character recognition unit 30A or the character recognition unit 30B) of the book digitization apparatus 1A or 1B may be implemented by a logic circuit (hardware) formed in an integrated circuit (IC chip) or the like or may be implemented by software.

In the latter case, the book digitization apparatus 1A or 1B includes a computer that executes a command of a program that is software implementing each of the functions. For example, the computer includes at least one processor (control apparatus) and includes at least one computer readable recording medium having the program stored therein. The disclosure is provided when the processor reads and executes the program from the recording medium in the computer. As the processor, for example, a central processing unit (CPU) is able to be used. As the recording medium, in addition to a read only memory (ROM) or the like, a “non-transitory tangible medium” such as a tape, a disk, a card, a semiconductor memory, or a programmable logic circuit is able to be used. Further, a random access memory (RAM) that develops the program, or the like may be further included. Moreover, the program may be supplied to the computer via any transmission medium. (such as a communication network or a broadcast wave) which allows the program to be transmitted. Note that, an aspect of the disclosure can also be implemented in a form of a data signal in which the program is embodied through electronic transmission and which is embedded in a carrier wave.

### CONCLUSION

A character recognition apparatus according to an aspect 1 of the disclosure includes: a three-dimensional data generation unit that captures an image of a book and generates three-dimensional data of the book; a two-dimensional page data generation unit that generates, from the three-dimensional data, two-dimensional page data that includes information about a plurality of points each having a value corresponding to ink or a value corresponding to a background; and a recognition unit that extracts a plurality of unique points of a character from the plurality of points which are included in the two-dimensional page data and each of which has the value corresponding to the ink, thereby recognizing the character.

The character recognition apparatus according to an aspect 2 of the disclosure may further include a storage unit that stores data of the unique points, in which the recognition unit may refer to the data of the unique points stored in the storage unit and recognize the character, in the aspect 1.

In the character recognition apparatus according to an aspect 3 of the disclosure, the recognition unit may include a unique point data generation unit that generates data of the unique points in accordance with a past character recognition result, and the character may be recognized by referring to the data of the unique points, which is generated by the unique point data generation unit, in the aspect 1.

In the character recognition apparatus according to an aspect 4 of the disclosure, the recognition unit may extract a part of the unique points of the character from the plurality of points each having the value corresponding to the ink thereby recognizing the character, in any one of the aspects 1 to 3.

A character recognition method according to an aspect 5 of the disclosure includes: capturing an image of a book and generating three-dimensional data of the book; generating, from the three-dimensional data, two-dimensional page data that includes information about a plurality of points each having a value corresponding to ink or a value corresponding to a background; and extracting a plurality of unique points of a character from the plurality of points which are included in the two-dimensional page data and each of which has the value corresponding to the ink, thereby recognizing the character.

The disclosure is not limited to each of the embodiments described above, and may be modified in various manners within the scope indicated in the claims and an embodiment achieved by appropriately combining techniques disclosed in each of different embodiments is also encompassed in the technical scope of the disclosure. Further, by combining the techniques disclosed in each of the embodiments, a new technical feature may be formed.

The present disclosure contains subject matter related to that disclosed in Japanese Priority Patent Application JP 2018-111354 filed in the Japan Patent Office on Jun. 11, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A character recognition apparatus comprising:
a three-dimensional data generation unit that captures an image of a book and generates three-dimensional data of the book;
a two-dimensional page data generation unit that generates, from the three-dimensional data, two-dimensional page data that includes information about a plurality of points each having a value corresponding to ink or a value corresponding to a background; and
a recognition unit that extracts a plurality of unique points of a character from the plurality of points which are included in the two-dimensional page data and each of which has the value corresponding to the ink, thereby recognizing the character.

2. The character recognition apparatus according to claim 1, further comprising
a storage unit that stores data of the unique points, wherein
the recognition unit refers to the data of the unique points stored in the storage unit and recognizes the character.

3. The character recognition apparatus according to claim 1, wherein
the recognition unit includes a unique point data generation unit that generates data of the unique points in accordance with a past character recognition result, and
the character is recognized by referring to the data of the unique points, which is generated by the unique point data generation unit.

4. The character recognition apparatus according to claim 1, wherein the recognition unit extracts a part of the unique points of the character from the plurality of points each having the value corresponding to the ink, thereby recognizing the character.

5. A character recognition method comprising:
capturing an image of a book and generating three-dimensional data of the book;
generating, from the three-dimensional data, two-dimensional page data that includes information about a plurality of points each having a value corresponding to ink or a value corresponding to a background; and
extracting a plurality of unique points of a character from the plurality of points which are included in the two-dimensional page data and each of which has the value corresponding to the ink, thereby recognizing the character.
